(19) United States
(12) Patent Application Publication
(10) Pub. No.: US 2009/0201161 A1
(43) Pub. Date: Aug. 13, 2009

(54) SYSTEM AND METHOD FOR INDICATING EVACUATION STATUS

(76) Inventors: Saundra Janese Stevens, West Union, OH (US); Robert Glenn Fuller, West Union, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/348,989

(22) Filed: Jan. 6, 2009

Related U.S. Application Data
(63) Continuation-in-part of application No. 11/764,197, filed on Jun. 16, 2007, now abandoned.
(60) Provisional application No. 60/816,379, filed on Jun. 26, 2006.

(51) Int. Cl. G08B 23/00

(52) U.S. Cl. 340/573.4

(57) ABSTRACT

A device used in institutions such as, but not limited to, hospitals, nursing homes, and other patient-care facilities, and hotels motels, schools, dormitories and cruise ships which, when activated, provides a visual indication locally, or at or near the room to which it is attached, as to whether or not a particular room has been evacuated during an emergency evacuation situation.

### CROSS-REFERENCE TO RELATED APPLICATIONS

This application is a continuation-in-part of U.S. patent application Ser. No. 11/764,197 filed on Jun. 16, 2007 which claims the priority benefit of U.S. provisional patent application No. 60/816,379 filed on Jun. 26, 2006, the disclosures of which are expressly incorporated herein in their entireties.

### STATEMENT REGARDING FEDERALLY SPONSORED RESEARCH

Not Applicable

### REFERENCE TO APPENDIX

Not Applicable

### FIELD OF THE INVENTION

The field of the present invention generally relates to systems and methods for evacuating structures having a plurality of inhabited rooms and, more particularly, to systems and methods for keeping track of which rooms have been evacuated.

### BACKGROUND OF THE INVENTION

Many hospitals and nursing homes are required by state, federal, and international laws to establish and document evacuation procedures. In the case of a fire emergency, these institutions are required, among other things, to document a method for evacuating all patients from their rooms to a safe area. One critical aspect of the evacuation process is effective communication among staff as to which rooms have been evacuated. State, federal, and in some cases, international regulations leave the method of communication up to each institution's administration. As such, several techniques have been developed. These include, but are not limited to, the use of pillow cases left on the floor outside the evacuated room, orange tags placed on a hook on the outside of the door of the evacuated room, and the use of a chalk mark on the outside of the door of the evacuated room. Each of these communication systems has weaknesses and dies not provide the most efficient method of communicating the evacuation status of the affected room. These methods put patients, staff, and rescue personnel at unnecessary risk. In general, the shortcomings of each of these devices, and other similar devices not mentioned here, are the following: 1. They require retrieval from some storage location—the current methods utilize items that are not located at the point of use. Therefore they may have to be retrieved at the time of the emergency. This takes valuable time away from the evacuation process; 2. The items utilized could be misplaced—the items utilized in the current methods are not affixed to the point of use possibly resulting in being misplaced and not available at the time of the emergency; 3. Application of the method is clumsy and/or difficult—getting the pillowcase off of the pillow is clumsy and placing a sign on a hook can be difficult in a tense situation thus again wasting valuable time; 4. The methods and devices may not hold up to either he heat from a fire (in the case of the chalk or the sign) or the traffic of the evacuation process (in the case of a pillow case on the floor). In either case, the indicator is rendered inadequate resulting in no communication to other evacuation personnel; and 5. These methods and devices would be difficult to see in conditions of poor visibility (i.e. smoke or dim to no light).

Accordingly, there is a need in the art for an improved system and method for communicating the status of an evacuation.

### SUMMARY OF THE INVENTION

The present invention provides a system and method for indicating evacuation status which overcomes at least some of the above-noted problems of the related art. According to a disclosed embodiment of the present invention, an Evacuation Status Indicator (ESI) is provided which, when activated, indicates that the room to which it is attached, has been evacuated of all occupants. The use of the ESI saves lives by saving rescue personnel valuable time during an emergency evacuation. It eliminates the need to search a room that has already been evacuated. As a result, rescue personnel can proceed to other rooms or areas of the affected premises that have not been evacuated. The ESI is mounted on the exterior side of a room near or on the room's exit door. During an evacuation situation, when all occupants have been removed from (or have exited) the room, the ESI is activated. It then serves as an indicator to anyone searching or evacuating at a later time that the room is empty.

The disclosed device solves problems with other prior methods by providing: 1. easy access (i.e. the device does not have to be retrieved to be used and it is mounted to the outside of the door or adjacent frame); 2. known whereabouts at all times; 3. simple application (press of a button); 4. durability in extreme conditions (i.e. the device will hold up to extreme conditions such as heat because it is made of heat resistant material such as metal, composite, or high temperature polymer); and 5. high visibility (i.e. the device is coated with a highly visible reflective coating such as heat resistant paint, anodized coating, or other mechanically or electrodeposited coating which makes it more able to be seen in poor visibility conditions such as smoke or dim-to-no light).

From the foregoing disclosure and the following more detailed description of various preferred embodiments it will be apparent to those skilled in the art that the present invention provides a significant advance in the technology and art of systems and methods of indicating evacuation status. Particularly significant in this regard is the potential the invention affords for providing a reliable and low cost device. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of an Evacuation Status Indicator (ESI) according to a first embodiment of the invention wherein the ESI in an “open” or “activated” state;

FIG. 2 is a perspective view of the ESI of FIG. 1 wherein the ESI is in a “closed” or “inactive” state;

FIG. 3 is a perspective view of an Evacuation Status Indicator (ESI) according to a second embodiment of the invention wherein the ESI in a “closed” or “inactive” state;

FIG. 4 is a perspective view of the ESI of FIG. 3 wherein the ESI is in an “open” or “activated” state;

FIG. 5 is a side elevational view of the ESI of FIGS. 3 and 4 wherein the ESI is affixed to a structure and in a “closed” or “inactive” state;

FIG. 6 is a side elevational view of the ESI of FIGS. 3 to 5 wherein the ESI is affixed to a structure and in an “open” or “activated” state; and

FIG. 7 is a perspective view of an interior hallway of a structure wherein a plurality of the ESI of FIGS. 1 to 6 is affixed in close proximity to room doors in the hallway.

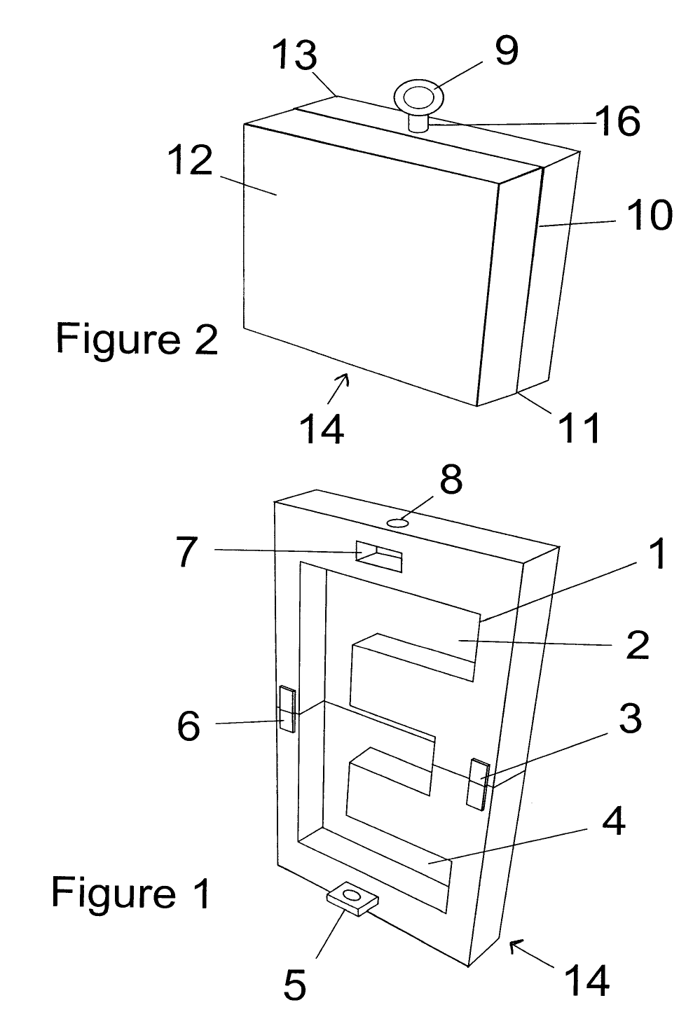

It should be understood that the appended drawings are not necessarily to scale, presenting a somewhat simplified representation of various preferred features illustrative of the basic principles of the invention. The specific design features of the systems and methods for indicating evacuation status as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the adjustable control pedal assemblies illustrated in the drawings. In general, up or upward refers to an upward direction within the plane of the paper in FIG. 1 and down or downward refers to a downward direction within the plane of the paper in FIG. 1. Also in general, fore or forward refers to a direction out of the plane of the paper in FIG. 1 and aft or rearward refers to a direction into the plane of the paper in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved systems and methods disclosed herein. The following detailed discussion of various alternative and preferred embodiments will illustrate the general principles of the invention with reference to an evacuation status indicator for use in a hospital, nursing home, other patient care facility, hotel, motel, school, dormitory, cruise ship, or the like. Other embodiments suitable for other applications will be apparent to those skilled in the art given the benefit of this disclosure.

FIGS. 1 and 2 illustrate an Evacuation Status Indicator (ESI) or device 14 according to a first disclosed embodiment of the present invention. The disclosed ESI 14 includes first and second components 12, 13 affixed together and moveable relative to one another between an open state wherein a visual stimulus 1 recognizable by personnel in the field of emergency protocol is visible to indicate that evacuation of a room has occurred and a closed state wherein the visual stimulus 1 is not visible to indicate evacuation of the room has not occurred and a latch mechanism 16 removably holding the first and second components 12, 13 in the closed state until an external input is selectively applied to move the first and second components 12, 13 to the open state.

Referring to FIG. 2, the ESI 14 can be seen in the “inactive” state. The illustrated ESI 14 is shown to be a rectangular cube. However, the ESI 14 can alternatively be shaped in any number of other suitable three-dimensional forms. In the closed state, the ESI 14 is shown to have two halves or components 12, 13 with the first or front (or bottom) half 12 separated from the second or rear (or top) half 13 by a parting line 10. The rear (or top) half 13 is rigidly connected to a wall or door while the front (or bottom) half 12 is pivotably connected to the rear (or top) half 13. The front and rear components 12, 13 are hinged together about a horizontal pivot axis 15 at the bottom of the components 12, 13 so that the front component 12 overlies the rear component 13 in the closed state and a top of the front component 12 pivots downward and outward about the pivot axis 15 to a position located below the rear component 13 in the open state. The device 14 preferably holds up to extreme conditions such as heat because the components 12, 13 are each made of a heat resistant material such as metal, composite, high temperature polymer, or the like.

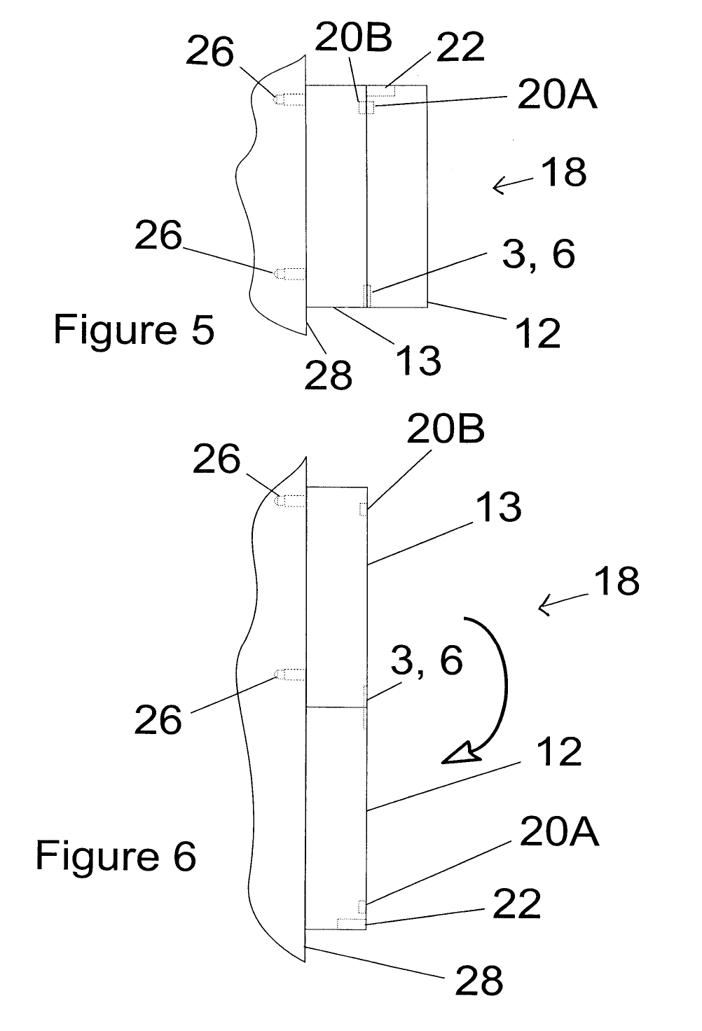

The rear half 13 is mounted on the exterior side of a room near or on the room's exit door (best shown in FIGS. 5 to 7). The rear half 13 can be mounted in an suitable manner such as adhesive, double back tape, mechanical fasteners, hooks, and/or any other suitable fastening means.

Connecting the rear (or top) half 13 of the illustrated device 14 to the front (or bottom) half 12 of the device 14 are a left side mechanical energy storage device/hinge 6 and a right side mechanical energy storage device/hinge 3. For simplicity, these mechanical energy storage devices will be referred to as “spring hinges” 3, 6. The purpose of these two spring hinges 3, 6 is to cause the closed device 14 to spring open when activated and stay open until such time as an authorized person returns the device 14 to the “inactive state”. It is noted that the spring hinges 3, 6 can alternatively be any other suitable type of hinge or hinges and/or the device 14 can alternatively rely on any other suitable type of force such as gravity to move and hold the device in the active state. It is also noted that a spring separate from the hinges 3, 6 can be provided for urging the first and second components 12, 13 to the open state.

The illustrated latch mechanism 16 includes a male end 5 secured to the front half 12, a female end 7 secured to the rear half 13 and sized for receiving the mail end 5, and a locking pin 9 which selectively extends into a hole 8 in the rear half 13 and through an opening in the male end 5 when the ESI 14 is in its closed state to selectively secure the ESI 14 in the closed state. The device 14 is activated by pulling the locking pin 9 from the opening 8 so that the male end 5 is released. When the locking pin 9 is pulled, the device 14 opens along the parting line 10 by rotating the front half 12 about the hinged end 11 of the device 14. It is noted that the latch mechanism 16 can alternatively be any other suitable type of latch mechanism.

The device 14 can be seen in the “active” state in FIG. 1. The “active” state of the device reveals the visual stimulus 1 on the inside of the device 14. The disclosed visual stimulus 1 is in the form of the letter “E”, however the visual stimulus can alternatively be any letter, symbol, sign, or other rendering common to the field of emergency protocol, personnel in the field of emergency protocol, and/or that which is compliant with local, state, federal, or national codes. The visual stimulus 1 serves as a visual and palpable indicator that the associated room has been evacuated.

The illustrated visual stimulus 1 in the form of a cavity 2. The visual stimulus 1 is preferably one of embossed or debossed in the first and second components so that personnel in the field of emergency protocol can alternatively feel the visual stimulus in poor visibility conditions. The illustrated visual stimulus 1 has a coating 4 that is capable of withstanding high temperatures and has a reflective appearance when subjected to a light source. The nature of this coating 4 is such that it enhances visibility in times of poor visibility such as dark or smoky conditions. The color of the coating 4 is selected from those common to the field of emergency protocol, personnel in the field of emergency protocol, and/or in compliance with local, state, federal, or international codes. This could include highly visible and reflective coatings. The coating 4 can be, for example, heat resistant paint, anodized coating, or other mechanically or electrodeposited coating which makes it more able to be seen in poor visibility conditions such as smoke or dim-to-no light.

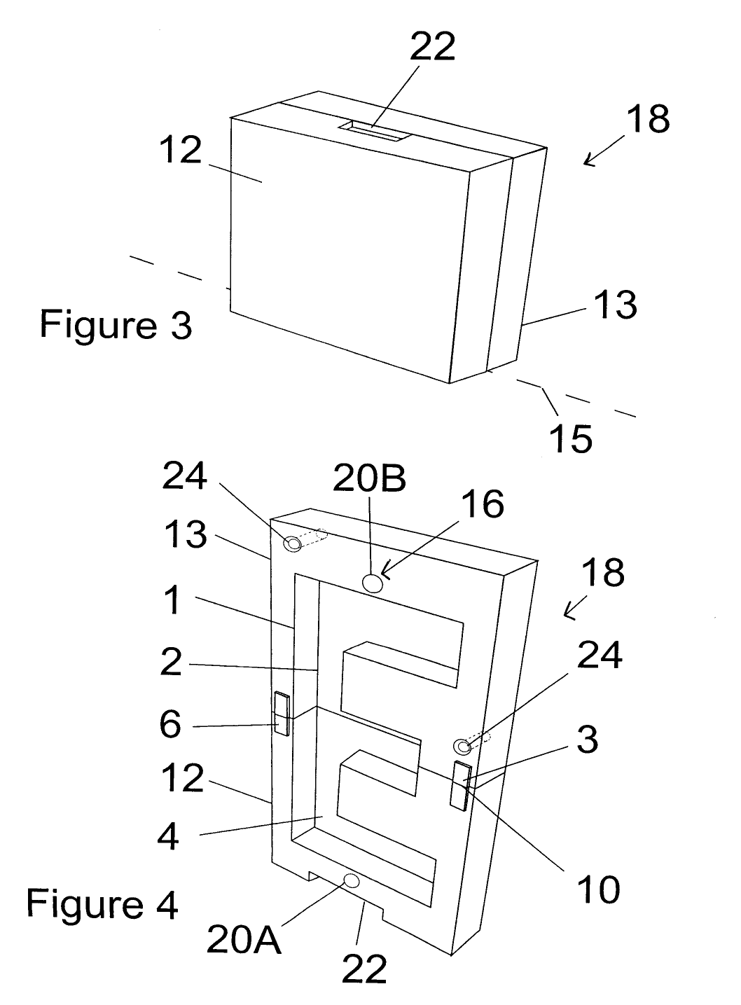

FIGS. 3 to 6 illustrate an Evacuation Status Indicator (ESI) or device 18 according to a second disclosed embodiment of the present invention. The ESI 18 according to the second embodiment is substantially the same as the ESI 14 according to the first embodiment except that the latch mechanism and mounts are different to illustrate that the scope of the present invention includes different latch mechanism and mounts. Additionally, the hinges 3, 6 do not include spring members to illustrate that the scope of the present invention includes different hinges. The illustrated ESI 18 includes a latching mechanism 16 in the form of a magnet latch secured in a position that releasably holds the components 12, 13 together in the inactive state. The illustrated magnet latch is a rare earth magnet latch that includes a pair of rare earth magnets 20A, 20B securely mounted in the front half 12 and the second half 13 respectively with their attracting poles oriented toward each other so that magnetic attraction between the magnets 20A, 20B releasably holds the components 12, 13 together. It is noted that the magnetic latch can alternatively have any other suitable quantity of magnets 20A, 20B. The illustrated front half 12 is provided with a groove or recess 22 at is free end to form a hand grip for pulling the free end to manually release the magnetic connection formed by the magnets 20A, 20B. The device 18 is activated by manually pulling the free end of the front half 12 until the magnet latch 20 is released. When the magnet latch 20 is released, the device 18 opens along the parting line 10 by rotating the front half 12 about the hinged end 11 of the device 14 and is held in the activated state by gravity. It is noted that the latch mechanism 16 can alternatively be any other suitable type of latch mechanism.

The illustrated ESI 18 includes a mount in the form of openings 24 formed in the rear half 13 and mechanical fasteners 26 extending through the openings 24 and into a structure 28 to mount the rear half 13 in a fixed position in proximity to a door, that is, near or on the door. The illustrated mechanical fasteners 26 are in the form of screws but can alternatively be any other suitable type of mechanical fasteners. It is noted that the structure 28 can be any structure having a plurality of inhabited rooms such as, for example, a hospital, nursing home, other patient care facility, hotel, motel, school, dormitory, cruise ship, or the like.

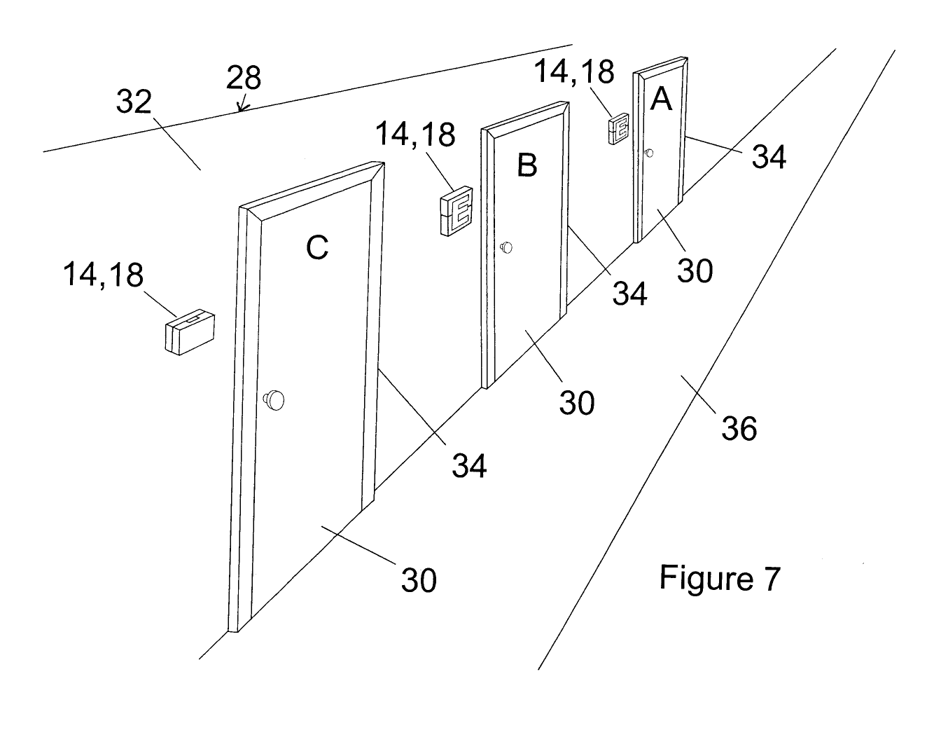

FIG. 7 illustrates the system for indicating evacuation status having a plurality of the ESI 14, 18 mounted to the facility or structure 28. The ESI 14, 18 are mounted on the exterior side of a plurality of rooms near the exit doors 30 of the rooms on the walls 32 or door frames 34 or on the exit doors 30 of the rooms. The illustrated ESI 14, 18 are mounted in close proximity of the exit doors 30 in an interior hallway 36 of the structure 28 but alternatively can be located on the exterior portion of the structure 28. Within this specification and claims, the term “close proximity” is intended to mean on the door, on a frame of the door, or on a wall or other object adjacent the door or frame within a few feet of the door or frame. During an evacuation situation, when all occupants have been removed from (or have exited) the room, the ESI 14, 18 is activated. When the ESI 14, 18 is activated, it indicates that the room to which it is attached has been evacuated of all occupants. The activated ESI 14, 18 serves as an indicator to anyone searching or evacuating at a later time that the room is empty. As a result, rescue personnel can proceed to other rooms or areas of the affected premises that have not been evacuated. The process of activating multiple devices 14, 18 in a given facility during an emergency evacuation provides the status of the evacuation to rescue personnel and staff. For example, as shown in FIG. 7, the ESI 14, 18 associated with rooms A and B have been activated to indicate that the rooms have been evacuated while the ESI 14, 18 associated with room C has not been activated which indicates that the room has not been evacuated. Thus, upon seeing or feeling the devices 14, 18, rescue personnel would know to focus on room C to look for additional residents to be evacuated. After, the emergency situation is over, the device 14, 18 are deactivated by closing each device 14, 18 to its closed state. The Devices 14, 18 can be reused without limit assuming they are not burned or destroyed during an evacuation event.

From the foregoing disclosure and detailed description of certain preferred embodiments, it is apparent that the ESI provides a consistent, efficient method for indicating the evacuation status of the room to which it is attached. Once triggered, it will indicate that the room to which it is attached has been evacuated in the following way: physical, visual indication hanging on, or near, a door to a particular room displaying an evacuation symbol common to those in the building. It will improve the evacuation process of institutions where it is used and will save lives of patients, staff, and rescue personnel by eliminating duplicate searches of rooms previously evacuated.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A system for indicating status of an evacuation comprising:
a structure having a room with a door;
an evacuation status indicator mounted at an exterior of the room in close proximity to the door;
wherein the evacuation status indicator includes first and second components affixed together and moveable relative to one another between an open state wherein a visual stimulus recognizable by personnel in the field of emergency protocol is visible to indicate that evacuation of the room has occurred and a closed state wherein the visual stimulus is not visible to indicate evacuation of the room has not occurred;
wherein the evacuation status indicator further includes a latch mechanism removably holding the first and second components in the closed state until an external input is selectively applied to move the first and second components to the open state;
wherein the second component is rigidly secured to the structure and the first component is movably secured to the second component; and
wherein the evacuation status indicator is moved from the closed state to the open state when evacuation of the room has occurred.

2. The system according to claim 1, wherein the visual stimulus is one of embossed or debossed in the first and second components so that personnel in the field of emergency protocol can alternatively feel the visual stimulus in poor visibility conditions.

3. The system according to claim 1, wherein the first and second components are hinged together.

4. The system according to claim 3, wherein the first and second components are hinged together about a horizontal pivot axis at the bottom of the second component so that the first component overlies the second component in the closed state and a top of the first component pivots downward and outward about the pivot axis to a position located below the second component in the open state.

5. The system according to claim 1, wherein the first and second components comprise a heat resistant material.

6. The system according to claim 5, wherein the first and second components comprise metal and the visual stimulus is formed in the metal.

7. The system according to claim 1, wherein the visible stimulus is provided with a reflective coating.

8. The system according to claim 1, wherein the visible stimulus comprises at least one of an alphanumeric character, sign, symbol, and rendering.

9. The system according to claim 1, wherein the visible stimulus is comprised of a single alphanumeric character.

10. The system according to claim 9, wherein the first and second components each form a portion of the single alphanumeric character.

11. A system for indicating status of an evacuation comprising:
a structure having a plurality of rooms each with a door;
a plurality of evacuation status indicators mounted at an exterior of the rooms in close proximity to the doors;
wherein each of the evacuation status indicators includes first and second components affixed together and moveable relative to one another between an open state wherein a visual stimulus recognizable by personnel in the field of emergency protocol is visible to indicate that evacuation of the associated one of the rooms has occurred and a closed state wherein the visual stimulus is not visible to indicate that evacuation of the associated one of the rooms has not occurred; and
wherein each of the evacuation status indicators further includes a latch mechanism removably holding the first and second components in the closed state until an external input is selectively applied to move the first and second components to the open state;
wherein the second component is rigidly secured to the structure and the first component is movably secured to the second component; and
wherein the evacuation status indicator is moved from the closed state to the open state when evacuation of the room has occurred.

12. The system according to claim 11, wherein the visible stimulus comprises a single alphanumeric character and the first and second components each form a portion of the single alphanumeric character.

13. The system according to claim 11, wherein the first and second components are hinged together.

14. The system according to claim 13, wherein the first and second components are hinged together about a horizontal pivot axis at the bottom of the second component so that the first component overlies the second component in the closed state and a top of the first component pivots downward and outward about the pivot axis to a position located below the second component in the open state.

15. The system according to claim 11, wherein the visible stimulus is provided with a reflective coating.

16. The system according to claim 11, wherein the first and second components comprise a heat resistant material.

17. The system according to claim 16, wherein the first and second components comprise metal and the visual stimulus is formed in the metal.

18. The system according to claim 11, wherein the visible stimulus comprises at least one of an alphanumeric character, sign, symbol, and rendering.

19. The system according to claim 11, wherein the visual stimulus is one of embossed or debossed in the first and second components so that personnel in the field of emergency protocol can alternatively feel the visual stimulus in poor visibility conditions.

20. A method for indicating status of an evacuation comprising:
providing a structure having a room with a door;
mounting an evacuation status indicator at an exterior of the room in close proximity to the door, wherein the evacuation status indicator includes first and second components affixed together and moveable relative to one another between an open state wherein a visual stimulus recognizable by personnel in the field of emergency protocol is visible to indicate that evacuation of the room has occurred and a closed state wherein the visual stimulus is not visible to indicate evacuation of the room has not occurred, and a latch mechanism removably holding the first and second components in the closed state until an external input is selectively applied to move the first and second components to the open state;
rigidly securing the second component to the structure with the first component movably secured to the second component; and
moving the evacuation status indicator from the closed state to the open state when evacuation of the room has occurred.
